(19) United States
(12) Patent Application Publication
(10) Pub. No.: US 2026/0031417 A1
(43) Pub. Date: Jan. 29, 2026

(54) FAST CHARGING SYSTEMS AND METHODS

(71) Applicant: Apple Inc., Cupertino, CA (US)

(72) Inventors: Tianheng Feng, San Jose, CA (US); Wei He, San Jose, CA (US); Guangyu Liu, San Jose, CA (US); Suhak Lee, Santa Clara, CA (US); Sara Sattarzadeh, San Diego, CA (US); Yuanzhi Liu, San Diego, CA (US)

(21) Appl. No.: 18/784,369

(22) Filed: Jul. 25, 2024

(51) Int. Cl. H01M 10/44; H01M 10/42; H01M 10/48

(52) U.S. Cl. CPC H01M 10/443; H01M 10/425; H01M 10/486; H01M 2010/4271; H01M 2010/4278

(57) ABSTRACT

A battery configured to power a device includes a battery management unit (BMU). The BMU is configured to determine a fast charging handshake criteria based at least in part on a temperature of the battery and an aging condition of the battery. The BMU is also configured to transmit a fast charging handshake initiation signal based at least in part on a battery characteristic of the battery satisfying the fast charging handshake criteria.

### BACKGROUND

The present disclosure relates generally to a battery configured to power an electronic device. More specifically, the present disclosure relates to determining when the battery is in a condition for supporting a fast charging handshake (or a portion thereof) between the electronic device and a charger, and techniques for initiating a fast charging protocol via the fast charging handshake.

A battery, such as a secondary or rechargeable battery (e.g., lithium-ion battery, lithium iron phosphate battery, lithium-ion polymer battery, nickel-cadmium battery, nickel-metal hydride battery, lead-acid battery, etc.), may be employed to power an electronic device, such as a consumer electronic device. The battery may be charged by way of a charger, such as a charger electrically coupled to an electrical outlet (e.g., a wall outlet), a power brick or power bank charger, etc. Traditional charging techniques may include a normal charging protocol, sometimes referred to as a slow charging protocol, and a fast charging protocol that charges the battery at a higher rate than the normal charging protocol.

The normal charging protocol may be employed in traditional configurations, for example, when the electronic device is in certain low power modes (e.g., low battery discharge modes) due to insufficient charge of the battery. For example, the low power modes may include a dali power mode, in which a charge of the battery is low and functionality of the electronic device and operating system thereof is reduced by a first extent, and a snake power mode, in which the charge of the battery is even lower and functionality of the electronic device and operating system thereof is reduced to a second extent greater than the first extent. The fast charging protocol may be employed in traditional configurations when the electronic device is in a normal power mode, in which the charge of the battery is greater than that of the snake power mode and the dali power mode, and in which full functionality of the electronic device and operating system thereof is available. In other traditional configurations, the normal charging protocol is employed when the electronic device is powered off due to insufficient charge of the battery, and the fast charging mode is employed when the electronic device is powered on with sufficient charge of the battery.

The fast charging protocol may be initiated in response to a fast charging handshake between the electronic device and the charger. The battery may directly provide power supporting a portion of the fast charging handshake handled by the electronic device (e.g., as opposed to being provided by the charger and/or the electrical outlet). Attempting the fast charging handshake before the battery is in a condition to support it (or a portion thereof) may result in negative effects, such as an undesirable voltage drop at the battery, a brownout, a failure of the fast charging handshake at the electronic device, other failures at the battery and/or electronic device, etc. Additionally or alternatively, performing the fast charging handshake to initiate the fast charging protocol well after the battery is in a condition to support it (or a portion thereof) may result in other negative effects, such as battery trap, an undesirable delay in powering on the electronic device and/or reaching the normal power mode, an undesirable amount of time to fully charge the battery, etc. Accordingly, it is now recognized that improved techniques relating to fast charging handshakes and fast charging protocols are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery configured to power a device includes a battery management unit (BMU). The BMU is configured to determine a fast charging handshake criteria based at least in part on a temperature of the battery and an aging condition of the battery. The BMU is also configured to transmit a fast charging handshake initiation signal based at least in part on a battery characteristic of the battery satisfying the fast charging handshake criteria.

In another embodiment, one or more tangible, non-transitory, computer-readable media stores instructions thereon that, when executed by a processing system including one or more processors, are configured to cause the processing system to perform various functions. The functions include determining a temperature of a battery, determining an aging condition of the battery, and determining, based at least in part on the temperature and the aging condition, a fast charging handshake criteria. The method also includes determining whether a battery characteristic of the battery satisfies the fast charging handshake criteria.

In another embodiment, a method includes determining, via a battery management unit (BMU) of a battery, a fast charging handshake criteria based at least in part on a temperature of the battery and an aging condition of the battery. The method also includes determining, via the BMU, whether a battery characteristic of the battery satisfies the fast charging handshake criteria. The method also includes transmitting, via the BMU, a fast charging handshake initiation signal in response to determining that the battery characteristic satisfies fast charging handshake criteria.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery configured to power a load, such as the electronic device of FIG. 1, and including a battery management unit (BMU) configured to transmit a fast charging handshake initiation signal in response to determining that the battery is in a condition for supporting a fast charging handshake (or a portion thereof) between the load and a charger, according to embodiments of the present disclosure;

FIG. 3 is a schematic illustration of logic (e.g., hardware and software) employed to determine when a battery, such as the battery of FIG. 2, is in a condition for supporting a fast charging handshake (or a portion thereof) between a load, such as the electronic device of FIG. 1, and a charger, according to embodiments of the present disclosure;

FIG. 4 is a block diagram of a portion of a load, such as the electronic device of FIG. 1, including various componentry, such as a charging management module, a power management module, and a battery management unit (BMU), configured to interact to initiate a fast charging protocol via a fast charging handshake between the load and a charger, according to embodiments of the present disclosure; and

FIG. 5 is a process flow diagram illustrating a method of determining when a battery, such as the battery of FIG. 2, is in a condition for supporting a fast charging handshake (or a portion thereof) between a load, such as the electronic device of FIG. 1, and a charger, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to techniques for initiating, via a fast charging handshake between an electronic device (e.g., a consumer electronic device, such as a smartphone or a smartwatch) and a charger (e.g., a charger coupled to an electrical outlet, a power brick or power bank charger, a wireless charger, etc.), a fast charging protocol for charging a battery of the electronic device via the charger. More particularly, this disclose is directed to techniques for determining when the battery is in a condition to support the fast charging handshake or a portion thereof handled by the electronic device. As described in detail below, presently disclosed embodiments initiate the fast charging protocol via the fast charging handshake to charge the battery at a more desirable time or range of times than traditional configurations, thereby negating, reducing, or mitigating negative effects relative to traditional configurations, such as battery trap, brownout, an undesirably long amount of time the electronic device is powered off due to low battery energy and/or power, an undesirably long amount of time it takes for the electronic device to reach a normal power mode (e.g., a normal battery discharge mode), an undesirably long amount of time to fully charge the battery, voltage drops in the battery, fast charging handshake failures, other failures at the electronic device and/or the battery, etc. These and other aspects of the present disclosure are described in detail below.

A battery, such as a secondary or rechargeable battery (e.g., lithium-ion battery, lithium iron phosphate battery, lithium-ion polymer battery, nickel-cadmium battery, nickel-metal hydride battery, lead-acid battery, etc.), may be employed to power a load, such as an electronic device (e.g., a consumer electronic device). Various power modes (e.g., battery discharge modes), including various low power modes and a normal power mode, may be employed in accordance with the present disclosure. For example, the various low power modes may include a dali power mode, in which a charge of the battery is low and functionality of the electronic device and operating system thereof is reduced by a first extent, and a snake power mode, in which the charge of the battery is even lower and functionality of the electronic device and operating system thereof is reduced to a second extent greater than the first extent. In a smartwatch, for example, the dali power mode may enable the smartwatch to display a time while disabling certain other functionality (e.g., accessing applications), and the snake power mode may enable the smartwatch to display a low power message while disabling certain other functionality (e.g. displaying the time and accessing applications). The various power modes may also include the normal power mode, in which the charge of the battery is higher than it is in the snake power mode and the dali power mode, and in which full functionality of the electronic device and operating system thereof is available.

In certain traditional configurations, a normal charging protocol, sometimes referred to as a slow charging protocol, is employed to charge the battery when the electronic device is coupled to a charger and in the snake power mode and/or the dali power mode, and the fast charging protocol is employed to charge the battery at a faster rate when the electronic device is coupled to the charger and in the normal power mode. Additionally or alternatively, the normal charging protocol (e.g., slow charging protocol) may be employed in certain traditional configurations when the electronic device is powered off, and the fast charging protocol may be employed in certain traditional configurations when the electronic device is powered on.

In accordance with the present disclosure, and as described in detail below, the electronic device and/or the charger may initiate the fast charging protocol via a fast charging handshake while the electronic device is powered off and/or in one of the low power modes (e.g., the dali power mode), unlike certain traditional configurations. For example, the battery may directly provide power supporting a portion of the fast charging handshake handled by the electronic device (e.g., as opposed to being provided by the charger and/or the electrical outlet to which the charger is coupled). Accordingly, embodiments of the present disclosure include a battery management unit (BMU) of the battery, sometimes referred to as a battery management system (BMS) of the battery, that determines when the battery is in a condition to support the portion of the fast charging handshake handled by the electronic device. For example, the BMU may determine one or more battery characteristics and determine, based on the one or more battery characteristics, whether the battery is in a condition for supporting the portion of the fast charging handshake handled by the electronic device. The one or more battery characteristics may include, for example, a battery characteristic (e.g., fast charging handshake criteria) derived at least in part from a battery model (e.g., an equivalent circuit battery model using a resistor-capacitor equivalent circuit programmed in the BMU, sometimes referred to as a virtual battery model), threshold state-of-charge (SOC), a state-of-charge at cutoff voltage (SOC_{Vcut}), an actual SOC, or some combination thereof. In this way, the BMU may determine when a power and energy capability of the battery is sufficient to support the portion of the fast charging handshake handled by the electronic device.

If the BMU determines that the battery is in a condition for supporting the portion of the fast charging handshake handled by the electronic device, the BMU may transmit a fast charging handshake initiation signal to another aspect of the electronic device, such as processing circuitry by way of a network interface, which may perform the fast charging handshake with the charger in response to receiving the fast charging handshake initiation signal. In some embodiments, the processing circuitry of the electronic device corresponds to a charging management module and/or a power management module of the electronic device. Upon completion of the fast charging handshake between the electronic device and the charger, the battery is charged by the charger via the fast charging protocol (e.g., at a higher charging rate than the normal charging protocol).

In general, presently disclosed embodiments improve upon a timing of the fast charging handshake relative to traditional configurations, thereby reducing or mitigating negative effects that would be associated with attempting the fast charging handshake undesirably early (e.g., possibly resulting in battery voltage drop, fast charging handshake failure, brownout, other failures at the battery and/or the electronic device, etc.) and performing the fast charging handshake undesirably late (e.g., possibly resulting in battery trap, an undesirably long period of time before the electronic device is powered on or reaches the normal power mode, an undesirably long period of time to fully charge the battery, etc.). These and other aspects of the present disclosure are described in detail below with reference to the drawings.

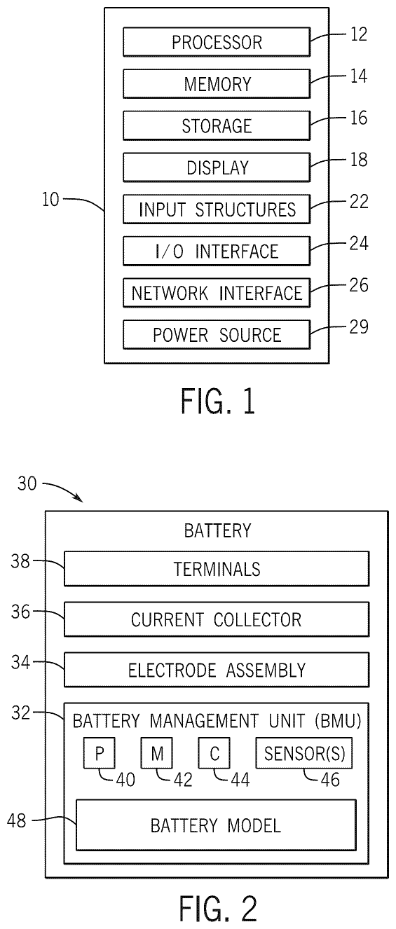

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power source 29 of the electronic device 10 may include any suitable source of power, such as a rechargeable lithium polymer (Li-poly) battery and/or an alternating current (AC) power converter. In accordance with embodiments of the present disclosure, the power source 29 may include a battery, such as a secondary or rechargeable battery (e.g., lithium-ion battery, lithium iron phosphate battery, lithium-ion polymer battery, nickel-cadmium battery, nickel-metal hydride battery, lead-acid battery, etc.). Presently disclosed embodiments, described in greater detail below, include techniques for determining when the battery is in a condition for supporting a fast charging handshake or a portion thereof handled by the electronic device 10, where the fast charging handshake between the electronic device 10 and a charger initiates a fast charging protocol in which the battery is charged at a relatively high rate (e.g., a higher rate than a normal charging protocol, sometimes referred to as a slow charging mode). These and other aspects of the present disclosure are described in detail below.

FIG. 2 is a block diagram of an embodiment of a battery 30 configured to power a load, such as the electronic device 10 of FIG. 1, and including a battery management unit (BMU) 32 configured to transmit a fast charging handshake initiation signal in response to determining that the battery 30 is in a condition for supporting a fast charging handshake (or a portion thereof) between the load and a charger. For purposes of brevity, the load will be referred to below as the electronic device 10 (e.g., illustrated in FIG. 1 below). As described in greater detail below, the BMU 32 may transmit the fast charging handshake initiation signal in response to determining that the battery 30 is capable of powering the portion of the fast charging handshake handled by the electronic device 10. That is, the BMU 32 may transmit the fast charging handshake initiation signal in response to determining that a power and energy capability of the battery 30 is sufficient to support the portion of the fast charging handshake handled by the electronic device 10.

In the illustrated embodiment, the battery 30 includes an electrode assembly 34 (e.g., including at least two electrodes and at least one separator), at least one current collector 36 electrically coupled with the electrode assembly 34, and terminals 38 electrically coupled with the at least one current collector 36. The terminals 38 are configured to be coupled to the electronic device 10 of FIG. 1 to enable the battery 30 to power the load. The terminals 38 are also configured to be electrically coupled to a charger that charges the battery 30. For example, the charger may be coupled to the electronic device 10 via a charging port, where componentry of the electronic device 10 establishes an electrical connection between the battery 30 and the charger. In other embodiments, a wireless charger may be employed. Although not shown in the illustrated embodiment, an enclosure of the battery 30 may be configured to receive the above-described componentry, or portions thereof, along with electrolyte configured to enable ionic movement between electrodes of the electrode assembly 34 during charging and discharging of the battery 30.

The BMU 32 of the battery 30 includes memory circuitry 40 storing instructions thereon, processing circuitry 42 configured to execute the instructions to perform various functions, communications circuitry 44 configured to transmit and/or receive communication signals (e.g., wired or wireless communication signals), and one or more sensors 46 configured to detect one or more battery characteristics of the battery 30. In some embodiments, the sensor(s) 46 are external to the BMU 32, and the BMU 32 is configured to receive sensor data from the sensor(s) 46. The BMU 32 in FIG. 2 also includes a battery model 48 (e.g., a virtual battery model, such as an equivalent circuit battery model) programmed therein and that may be employed to output, for example, one or more estimated or predicted battery characteristics (e.g., based at least in part on one or more detected battery characteristics). The battery model 48 may be implemented in the BMU 32 as a resistor-capacitor (RC) circuit to operate as a virtual battery by mimicking real behavior of the battery 30.

In some embodiments, the battery 30 is configured to power the electronic device 10 of FIG. 1, for example, in various power modes (e.g., various battery discharge modes), such as various low power modes and a normal power mode. As an example, the various low power modes may include a dali power mode, in which a charge of the battery 30 is low and functionality of the electronic device 10 and operating system thereof is reduced by a first extent, and a snake power mode, in which the charge of the battery 30 is even lower and functionality of the electronic device 10 and operating system thereof is reduced to a second extent greater than the first extent. As an example, the electronic device 10 may be capable of displaying a time and not be capable of accessing applications in the dali power mode, whereas the electronic device 10 may be capable of displaying a message indicating low power and not be capable of displaying the time and accessing applications in the snake power mode. The various power modes may also include the normal power mode, in which the charge of the battery 30 is higher than it is in the snake power mode and the dali power mode, and in which full functionality of the electronic device 10 operating system thereof is available.

As previously described, the battery 30 may directly provide power supporting the portion of the fast charging handshake handled by the electronic device 10 (e.g., as opposed to being provided by the charger and/or the electrical outlet). The portion of the fast charging handshake handled by the electronic device 10 may include, among other possible features, communications transmitted from the electronic device 10 to a charger, whereas an additional portion of the fast charging handshake handled by the charger may include, among other possible features, communications transmitted from the charger to the electronic device 10. The battery 30 supports the portion of the fast charging handshake handled by the electronic device 10 by powering the electronic device 10. Accordingly, a capability of the battery 30 to support the portion of the fast charging handshake handled by the electronic device 10 is important for the fast charging handshake to be successfully performed. Embodiments of the present disclosure include determining, via the BMU 32, that the battery 30 is capable of supporting the portion of the fast charging handshake handled by the electronic device 10 during one of the low power modes (e.g., the dali power mode), or otherwise while the electronic device 10 is powered off due to insufficient charge of the battery 30. In this way, the fast charging handshake can be performed (e.g., between the electronic device 10 and a charger) and a corresponding fast charging protocol, which charges the battery 30 at a higher rate than a normal or slow charging protocol, can be initiated earlier than in traditional configurations.

Continuing with the above discussion, the BMU 32 may be configured to determine one or more battery characteristics, such as fast charging handshake criteria, based at least in part on sensor data received from the sensors 46 and/or one or more outputs from the battery model 48. Further, the BMU 32 may determine whether the fast charging handshake criteria is met by one or more additional battery characteristics. As an example, the BMU 32 may determine an actual state-of-charge (SOC) of the battery 30, a state-of-charge at cutoff voltage (SOC_{Vcut}), and whether the actual SOC is equal to and/or exceeds the SOC_{Vcut}. Stated differently, the BMU 32 may determine whether a power and energy capability of the battery 30 is sufficient to support the portion of the fast charging handshake handled by the electronic device 10 of FIG. 1 (e.g., by way of a power and/or energy threshold, such as SOC_{Vcut}).

In response to determining that the one or more battery characteristics satisfy the fast charging handshake criteria (e.g., determining that the actual SOC is equal to and/or exceeds the SOC_{Vcut}, determining that the power and energy capability of the battery 30 is sufficient, etc.), the BMU 32 may transmit a fast charging handshake initiation signal, which may also be referred to as a fast charging enabling signal, to an aspect of the electronic device 10 of FIG. 1, such as the processor 12 by way of the network interface 26 in FIG. 1. The electronic device 10 may perform the fast charging handshake with the charger in response to the fast charging handshake initiation signal, drawing the power needed at the electronic device 10 to perform the fast charging handshake from the battery 30. Upon completion of the fast charging handshake, the charger may charge the battery 30 via the fast charging protocol at a fast charging rate that is higher than a normal (or slow) charging rate corresponding to a normal (or slow) charging protocol, as previously described.

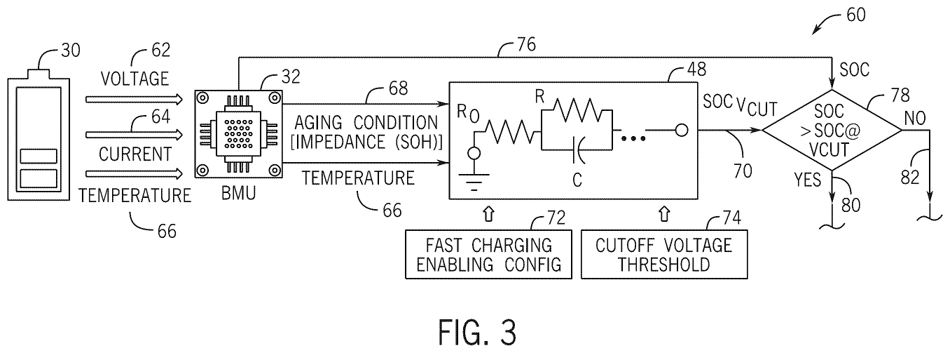

FIG. 3 is a schematic illustration of an embodiment of logic 60 (e.g., hardware and software) employed to determine when a battery, such as the battery 30 of FIG. 2, is in a condition for supporting a fast charging handshake (or a portion thereof) between a load, such as the electronic device 10 of FIG. 1, and a charger. While the BMU 32 and the battery 30 are illustrated as separate blocks in FIG. 3, it should be understood that the BMU 32 is a part of the battery 30. Further, while the BMU 32 is illustrated as a block separate from the logic 60 in FIG. 3, it should be understood that the logic 60 is programmed within the BMU 32 in certain embodiments. In the illustrated embodiment, the BMU 32 receives a first input 62 indicative of a voltage of the battery 30, a second input 64 indicative of a current of the battery 30, and a third input 66 indicative of a temperature of the battery 30. In some embodiments, the first input 62 indicative of the voltage of the battery 30, the second input 64 indicative of the current of the battery 30, and/or the third input 66 indicative of the temperature of the battery 30 correspond to sensor feedback received from the sensor(s) 46 illustrated in FIG. 2. That is, the sensor(s) 46 in FIG. 2 may be configured to detect the voltage, the current, and/or the temperature of the battery 30.

The BMU 32 may determine an estimated aging condition 68 of the battery 30, referred to in certain instances of the present disclosure as an impedance or state-of-health (SOH) of the battery 30, based at least in part on the first input 62 indicative of the voltage of the battery 30 and/or the second input 64 indicative of the current of the battery 30. In some embodiments, the aging condition 68 may be determined as a function of the third input 66 indicative of the temperature of the battery 30. The battery model 48 may be employed (e.g., by the BMU 32) to determine, based on the aging condition 68 of the battery 30 and the third input 66 indicative of the temperature of the battery 30, a state-of-charge at cutoff voltage (SOC_{Vcut}) 70. In this way, the SOC_{Vcut} 70 is variable and dependent upon the aging condition 68 of the battery 30 and the third input 66 indicative of the temperature of the battery 30. In some embodiments, the battery model 48 determines the SOC_{Vcut} 70 based on, in addition to the third input 66 indicative of the temperature of the battery 30 and the aging condition 68, a fast charging enabling configuration input 72 (e.g., corresponding to a capacity or energy input) and a cutoff voltage threshold input 74 (e.g., corresponding to a power support input). In this way, the processing step at block 78, described in greater detail below, ensures that the power and energy capability of the battery 30 is sufficient to support the portion of the fast charging handshake handled by the load, such as the electronic device 10 of FIG. 1. In some embodiments, the fast charging enabling configuration input 72, the cutoff voltage threshold input 74, some other input employed in the logic 60, or any combination thereof is based at least in part on a handshake power demand corresponding to power required from the battery 30 to support the fast charging handshake (e.g., the portion of the fast charging handshake handled by the electronic device 10 of FIG. 1).

In general, certain embodiments of the battery model 48 may be employed to determine transient voltage response, or current response, of the battery 30 to pulsed currents or voltages, and/or any other suitable time varying signals. In some embodiments, the model representation corresponds to an open circuit voltage of the battery 30 and series resistance of the battery 30. A learning cycle may be employed (e.g., via the BMU 32) to determine various parameters (e.g., variables, electrical characteristics, or outputs) of the equivalent circuit battery model 48 in certain embodiments, whereby the parameters may be used, for example, in an algorithm for determining the SOC_{Vcut} 70, as previously described, or some other battery characteristic. Thus, the battery model 48 may include software logic and/or hardware logic configured to model certain electrical characteristics (e.g., unknown characteristics) of the battery 30. That is, the battery model 48 may be implemented using a resistor-capacitor (RC) equivalent circuit programmed in the BMU 32 to mimic real behavior of the battery 30, as previously described. An example of battery modeling can be found in U.S. Pat. No. 10,830,821 by Lou et al., which is incorporated by reference herein. Further, an example of battery capability modeling can be found in U.S. Publication No. 20180345812 by Chaturvedi et al., which is incorporated by reference herein. However, it should be understood that any type of battery model may be employed in accordance with the present disclosure, including but not limited to an equivalent circuit battery model.

As shown in FIG. 3, the BMU 32 also determines an actual SOC 76 (e.g., operating SOC) of the battery 30 based on, for example, the second input 64 indicative of the current of the battery 30, or the first input 62 indicative of the voltage of the battery 30, or both. As represented by block 78, the BMU 32 may compare the operating SOC 76 with the SOC_{Vcut} 70. If the operating SOC 76 is greater than the SOC_{Vcut} 70, the BMU 32 transmits a fast charging handshake initiation signal 80, referred to in certain instances of the present disclosure as a fast charging enabling signal. If the operating SOC 76 is not greater than the SOC_{Vcut} 70, the BMU 32 does not transmit the fast charging handshake initiation signal 80, or transmits a signal 82 indicating that the battery 30 is not prepared to support the fast charging handshake (or a portion thereof), or both. In some embodiments, the fast charging handshake initiation signal 80 and the signal 82 indicating that the battery 30 is not prepared to support the fast charging handshake (or a portion thereof) may be binary (e.g., 1 and 0, respectively). As described in greater detail below, the fast charging handshake initiation signal 80 is configured to communicate, for example, to the electronic device 10 of FIG. 1 that the electronic device 10 may proceed with the fast charging handshake (e.g., with the charger).

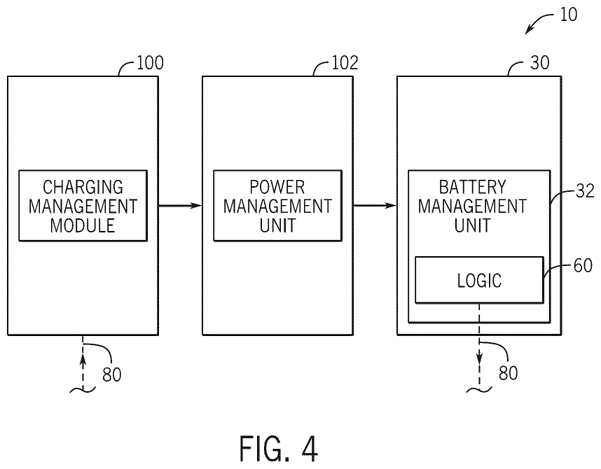

FIG. 4 is a block diagram of an embodiment of a portion of a load, such as the electronic device 10, including various componentry, such as a charging management module 100, a power management module 102, and the BMU 32, configured to interact to initiate a fast charging protocol via a fast charging handshake between the electronic device 10 and a charger. In the illustrated embodiment, the logic 60 described above with respect to FIG. 3 is employed (e.g., in whole or in part at the BMU 32) to transmit the fast charging handshake initiation signal 80 to the charging management module 100 of the electronic device 10. In some embodiments, the charging management module 100 of the electronic device 10 is configured to perform the fast charging handshake with the charger, or otherwise regulate the fast charging handshake and/or a charging speed. In some embodiments, the fast charging handshake includes communications transmitted between the electronic device 10 and the charger indicating the maximum power that the electronic device 10 may receive and the maximum power that the charger may-deliver. The power management module 102 may be configured to distribute the incoming power about the electronic device 10, such as to the battery 30, or otherwise regulate power distribution.

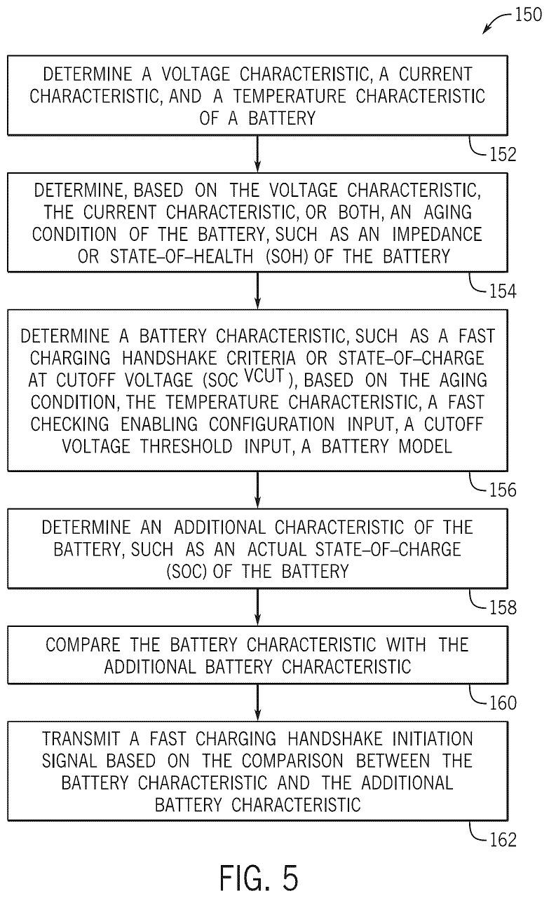

FIG. 5 is a process flow diagram illustrating an embodiment of a method 150 of determining when a battery, such as the battery 30 of FIG. 2, is in a condition for supporting a fast charging handshake (or a portion thereof) between a load, such as the electronic device 10 of FIG. 1, and a charger. For example, the method 150 may be employed to determine when the battery can support the portion (e.g., power and/or energy) of the fast charging handshake handled by the electronic device. Various steps of the method 150 illustrated in FIG. 5 and described below may be performed by a battery management unit (BMU) of the battery, such as the BMU 32 of the battery 30 of FIG. 2. An order of the steps of the method 150 illustrated in FIG. 5 and described below should not be taken as necessarily implying a chronology of the method 150 in all embodiments of the present disclosure. Indeed, while the method 150 may be performed in a chronology of the steps of the method 150 illustrated in FIG. 5 and described below, other chronologies are also possible. Further, it should be noted that other steps in accordance with the present disclosure that are not illustrated in FIG. 5 and described below may be employed in the method 150, and that certain steps of the method 150 illustrated in FIG. 5 and described below may be excluded in certain embodiments. Indeed, the method 150 illustrated in FIG. 5 and described below is merely an example. Other embodiments are also possible in accordance with the present disclosure.

In the illustrated embodiment, the method 150 includes determining (block 152) a voltage characteristic, a current characteristic, and/or a temperature characteristic of the battery. For example, sensors may be configured to detect the voltage characteristic, the current characteristic, and/or the temperature characteristic. The method 150 also includes determining (block 154), based on the voltage characteristic, the current characteristic, or both, an aging condition of the battery. The aging characteristic may include, may be associated with, or may be a function of an impedance or state-of-health (SOH) of the battery. In some embodiments, the aging condition may also be determined based on the temperature characteristic of the battery.

The method 150 also includes determining (block 156) a battery characteristic, such as a fast charging handshake criteria or state-of-charge at cutoff voltage (SOC_{Vcut}), based on the aging condition, the temperature characteristic, a fast charging enabling configuration input, a cutoff voltage threshold input, and/or a battery model (e.g., an equivalent circuit battery model, virtual battery model, resistor-capacitor equivalent circuit, etc.). For example, as previously described, the battery model may be employed to determine, based on the aging condition, the temperature characteristic, the fast charging enabling configuration input, the cutoff voltage threshold input, or a combination thereof, the battery characteristic (e.g., the fast charging handshake criteria, such as the SOC_{Vcut}). The method 150 also includes determining (block 158) an additional characteristic of the battery, such as an actual SOC of the battery. For example, the actual SOC of the battery may be derived from the voltage characteristic, the current characteristic, or both, or some other input or inputs.

The method 150 also includes comparing (block 160) the battery characteristic (e.g., the SOC_{Vcut}) with the additional battery characteristic (e.g., the actual SOC). For example, block 158 may include determining whether the additional battery characteristic (e.g., the actual SOC) is equal to and/or exceeds the battery characteristic (e.g., the fast charging handshake criteria, such as the SOC_{Vcut}). The method 150 also includes transmitting (block 162) a fast charging handshake initiation signal, also referred to as a fast charging enabling signal, based on the comparison between the battery characteristic and the additional battery characteristic. For example, the fast charging handshake initiation signal may be transmitted in response to the additional battery characteristic (e.g., the actual SOC) being equal to and/or exceeding the battery characteristic (e.g., the SOC_{Vcut}). The fast charging handshake initiation signal, which may be transmitted by the BMU of the battery to another aspect of the electronic device, is configured to cause the electronic device to perform the fast charging handshake with the charger, which initiates the fast charging protocol by which the charger charges the battery at a relatively high rate (e.g., a higher rate than a normal or slow charging protocol). In accordance with the present disclosure, and unlike certain traditional configurations, the BMU may transmit the fast charging handshake initiation signal (and initiate the fast charging protocol) while the electronic device is powered off and/or in a low power mode due to insufficient charge of the battery.

Presently disclosed embodiments improve upon a time of initiating a fast charging protocol in which a charger charges a battery at a higher rate than a normal (or slow) charging protocol. Technical benefits of present disclosed embodiments include negating, reducing, or mitigating negative effects associated with traditional configurations, such as battery trap, brownout, an undesirably long amount of time an electronic device is powered off due to low battery energy and/or power, an undesirably long amount of time it takes for the electronic device to reach a normal power mode (e.g., a normal battery discharge mode), an undesirably long amount of time to fully charge the battery, voltage drops in the battery, fast charging handshake failures, other failures at the electronic device and/or the battery, etc. These and other aspects of the present disclosure are described in detail below.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery configured to power a device, wherein the battery comprises a battery management unit (BMU) configured to:
determine a fast charging handshake criteria based at least in part on a temperature of the battery and an aging condition of the battery; and
transmit a fast charging handshake initiation signal based at least in part on an additional battery characteristic satisfying the fast charging handshake criteria.

2. The battery of claim 1, wherein the BMU is configured to determine an actual state-of-charge (SOC) of the battery, the actual SOC of the battery corresponding to the additional battery characteristic.

3. The battery of claim 2, wherein the BMU is configured to determine the actual SOC of the battery based on a current characteristic associated with the battery, a voltage characteristic associated with the battery, or both.

4. The battery of claim 1, wherein the BMU is configured to determine the aging condition of the battery based at least in part on a voltage characteristic associated with the battery, a current characteristic associated with the battery, or both.

5. The battery of claim 1, wherein the fast charging handshake criteria comprises a power threshold, an energy threshold, a state-of-charge (SOC) threshold, or any combination thereof.

6. The battery of claim 1, wherein the fast charging handshake criteria comprises a state-of-charge at cutoff voltage (SOC_{Vcut}).

7. The battery of claim 1, wherein the BMU is configured to transmit the fast charging handshake initiation signal while the device is powered off or the device is in a low power mode.

8. The battery of claim 1, wherein the BMU is configured to determine the fast charging handshake criteria based at least in part on a battery model that receives a first input corresponding to the temperature of the battery and a second input corresponding to the aging condition of the battery.

9. The battery of claim 1, wherein the aging condition comprises an impedance or state-of-health (SOH) of the battery.

10. One or more tangible, non-transitory, computer-readable media storing instructions thereon that, when executed by a processing system comprising one or more processors, are configured to cause the processing system to:
determine a temperature of a battery;
determine an aging condition of the battery;
determine, based at least in part on the temperature and the aging condition, a fast charging handshake criteria; and
determine whether a battery characteristic of the battery satisfies the fast charging handshake criteria.

11. The one or more tangible, non-transitory, computer-readable media of claim 10, wherein the instructions, when executed by the processing system, are configured to cause the processing system to transmit a fast charging handshake initiation signal based at least in part on the battery characteristic satisfying the fast charging handshake criteria and while a device comprising the battery is powered off or in a low power mode.

12. The one or more tangible, non-transitory, computer-readable media of claim 10, wherein the instructions, when executed by the processing system, are configured to cause the processing system to determine the aging condition of the battery based at least in part on a voltage characteristic associated with the battery, a current characteristic associated with the battery, or both.

13. The one or more tangible, non-transitory, computer-readable media of claim 10, wherein the fast charging handshake criteria comprises a threshold related to power, energy, state-of-charge (SOC), or any combination thereof.

14. The one or more tangible, non-transitory, computer-readable media of claim 10, wherein the battery characteristic comprises an actual state-of-charge (SOC) of the battery.

15. The one or more tangible, non-transitory, computer-readable media of claim 10, wherein the instructions, when executed by the processing system, are configured to cause the processing system to determine the fast charging handshake criteria based at least in part on the temperature, the aging condition, and a battery model.

16. A method, comprising:
determining, via a battery management unit (BMU) of a battery, a fast charging handshake criteria based at least in part on a temperature of the battery and an aging condition of the battery;
determining, via the BMU, whether a battery characteristic of the battery satisfies the fast charging handshake criteria; and
transmitting, via the BMU, a fast charging handshake initiation signal in response to determining that the battery characteristic satisfies the fast charging handshake criteria.

17. The method of claim 16, comprising determining, via the BMU, the aging condition of the battery based at least in part on a voltage characteristic associated with the battery, a current characteristic associated with the battery, or both.

18. The method of claim 16, wherein the fast charging handshake criteria comprises a threshold related to power, energy, state-of-charge (SOC), or any combination thereof.

19. The method of claim 16, comprising determining an actual state-of-charge (SOC) of the battery, the actual SOC corresponding to the battery characteristic.

20. The method of claim 16, wherein the aging condition comprises an impedance or state-of-health (SOH) of the battery.
